(19) United States
(12) Patent Application Publication
(10) Pub. No.: US 2005/0158367 A1
(43) Pub. Date: Jul. 21, 2005

(54) Liquid compositions comprising one or more medicaments

(75) Inventor: Michael Nyle Hershberger, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 10/758,997

(22) Filed: Jan. 16, 2004

(51) Int. Cl. A01N 43/04

(52) U.S. Cl. 424/442; 514/28

(57) ABSTRACT

The present invention relates to liquid compositions that are useful for treating and preventing condition in a companion animal, as well as methods of their use. More particularly, the present invention relates to liquid compositions comparing one or more medications.

### FIELD OF THE INVENTION

The present invention relates to liquid compositions that are useful for treating and preventing conditions in a companion animal, as well as methods of their use.

### BACKGROUND OF THE INVENTION

There are a number of conditions that can compromise the health of a companion animal. Medicaments can be used to treat these conditions and are currently typically administered by oral administration or injection, such that therapeutic amounts of the medicaments can be maintained in the animals either continuously or at least during a discrete period. However, current dosing methods present a number of difficulties. For example, oral administration of a pill or injection of a medicament to a companion animal requires the animal to cooperate or at least remain still. Since companion animals may frequently reject such treatments, which is largely out of the control of the companion animal, lack of or improper dosing may result in danger to the health of the companion animal.

Attempts have been made in the past to provide daily ration products including medicaments. U.S. Pat. No. 4,702,914 describes a veterinary sauce prophylactic that is described as a ketchup sauce for administering prophylactic ingredients on or with other foods fed to pets. The pet food sauce in the '914 patent is specifically described as a ketchup sauce, a tomato-based, ketchup sauce. However, such sauces tend to be very high in sugar, which can itself threaten the health of the animal, for example in overweight or senior animals, or those prone to pre-diabetic or diabetic conditions.

U.S. patent application Publication No. 2002/00225325 describes a method of providing oral vaccinations to an animal through drinking water or syrups. In particular, the addition of vaccines to water for chicken feeds is discussed. WO/02/02139 describes methods and supplements for admixing bacterial and viral antigens into a water-soluble vehicle such as drinking water or syrups.

WO/03/030653 discusses the addition of medicaments to an extruder during processing of meat. However, such addition can be particularly limited as a variety of medicaments are susceptible to degradation when subjected to the high pressures and temperatures that are characteristic of extrusion.

It is thus a need in the art to provide compositions suitable for companion animals, wherein the compositions have the following attributes: the compositions can be formed at low temperatures such that the integrity of medicaments which are ordinarily susceptible to the conditions of dry food extrusion can be maintained, the compositions are stable at ambient temperature for extended periods of time, and the compositions are palatable to the companion animal for ease of administration. In addition, compositions provided for the treatment of particular conditions allows a consumer to choose a specific composition based on the condition of interest. By providing a liquid supplement composition in the preferred embodiment of the current invention, the owner of the companion animal is able to choose an effective dosage of medicament needed for the animal based on age, size or breed, or based on information provided with the liquid supplement composition to control the amount of medicament that a pet is fed, such as daily, weekly or monthly as desired.

### SUMMARY OF THE INVENTION

The present invention overcomes the problems cited in the related art and provides a liquid composition that can be admixed, topped, or otherwise added to a pet food or ingested alone, wherein a safe and effective amount of a medicament is maintained in a stable form and provides medicinal benefits to a companion animal to treat various conditions. In the preferred embodiment of the current invention, medicaments that are susceptible to dry food extrusion are admixed into a gravy topper and maintained at ambient temperature. The gravy topper of the current invention further comprises a flavorant for palatability and for ease of administration to a pet.

### DETAILED DESCRIPTION OF THE INVENTION

Various documents including, for example, publications and patents, are recited throughout this disclosure. All such documents are hereby incorporated by reference. The citation of any given document is not to be construed as an admission that it is prior art with respect to the present invention.

All percentages and ratios are calculated by weight unless otherwise indicated. All percentages and ratios are calculated based on the total composition unless otherwise indicated.

Referenced herein are trade names for components including various ingredients utilized in the present invention. The inventors herein do not intend to be limited by materials under a certain trade name. Equivalent materials (e.g., those obtained from a different source under a different name or reference number) to those referenced by trade name may be substituted and utilized in the descriptions herein.

In the description of the invention various embodiments or individual features are disclosed. As will be apparent to the ordinarily skilled practitioner, all combinations of such embodiments and features are possible and can result in preferred executions of the present invention.

The compositions herein may comprise, consist essentially of, or consist of any of the features or embodiments as described herein.

While various embodiments and individual features of the present invention have been illustrated and described, various other changes and modifications can be made without departing from the spirit and scope of the invention. As will also be apparent, all combinations of the embodiments and features taught in the foregoing disclosure are possible and can result in preferred executions of the invention.

The present invention is directed to compositions and methods that are adapted for use by companion animals. As used herein, “companion animal” means a domestic animal. Preferably, “companion animal” means a domestic dog, cat, rabbit, ferret, horse, cow, or the like. More preferably, “companion animal” means a domestic dog or cat, particularly a domestic dog.

The term “condition” as used herein means any deviation from or interruption of the normal structure or function of any part, organ, or system in a companion animal that is manifested by a characteristic set of symptoms and signs and whose etiology, pathology, and prognosis may be known or unknown.

In addition, as used herein, “medicament” means anything that is utilized to treat a condition in a companion animal.

As used herein, “treat,” “treating,” “treatment” or the like means that administration of the referenced composition prevents, alleviates, ameliorates, inhibits, or mitigates one or more symptoms of the condition or the condition itself, or any like benefit in a companion animal.

### The Compositions of the Present Invention

The compositions herein are adapted for use by a companion animal. In this respect, as will be well-understood by the ordinarily skilled artisan, the primary use of the compositions described herein is for companion animal use and the compositions are therefore formulated as such.

The present invention relates to liquid supplement compositions that are useful for treatment of various conditions in animals. Preparation of a stable liquid supplement composition that may optionally be admixed or otherwise administered with one or more medicaments allows the owner of a companion animal to administer effective and metered quantities of a medicament on an as need basis, such as daily, weekly or monthly. In addition, medicaments that cannot otherwise be incorporated into dry food due to the extreme conditions associated with dry food extrusion processes can be admixed into a flavorful liquid supplement composition allowing for ease of administration of these medicaments to a pet, while maintaining efficacy of the medicament.

The present invention is directed to liquid compositions comprising:
(a) a medicament;
(b) a flavorant;
(c) water; and,
   wherein the composition is essentially free of sugars and wherein the composition is adapted for use by a companion animal. The present liquid compositions provided herein have a relatively low sugar content. For example, sugars can be deleterious to the health of a variety of companion animals, such as overweight or senior animals, or those prone to pre-diabetic or diabetic conditions. As used herein the term “sugars” refers collectively to monosaccharides and disaccharides such as, for example, glucose, sucrose, fructose, high fructose corn syrup, lactose, maltose and other sweetening agents. Thereby, as used herein, the term “essentially free of sugars,” for the purposes of the invention, means that the liquid compositions herein comprise less than about 10% sugars, alternatively less than about 5% sugars, alternatively less than about 2% sugars, alternatively less than about 1% sugars, and alternatively less than about 0.5% sugars, all by weight of the composition. As defined herein, the total amount of sugars present in a given composition includes any added sugars as well as any sugars naturally present in any component of the composition.

In other embodiments of the current invention, the composition is essentially free of tomato flavor. The term “tomato flavor” as used herein refers to flavorants that add tomato flavor including: fresh tomato, chopped tomato, pureed tomato, tomato paste, and other natural and artificial tomato flavorants.

Medicaments

The present compositions herein comprise one or more medicaments. Medicaments will be well-known to those of ordinary skill in the art, and the medicament chosen will be based upon the needs of the companion animal which is treated in accordance with the teachings herein. The medicament herein will be a drug, component thereof, or other composition that is used in the direct management of an animal to treat, prevent or alleviate the symptoms of a disease or other condition. Conditions that may be treated in accordance with the present invention include but are not limited to those associated with ectoparasites and endoprarasites generally, including flea, tick, mosquito, larvae, heartworm, hookworm, roundworm, whipworm, parvovirus, and other parasites. This is by way of example only, and the ordinarily skilled artisan will be able to select the medicament necessary for the desired treatment.

As a further example, heartworm conditions may be treated through use of one or more of the following medicaments, wherein the medicament is a component of the present compositions: moxidectin, ivermectin, pyrantel, milbemycin oxime, lufenuron, and selamectin. Ivermectin is considered by the inventors to be a particularly useful medicament herein.

In further embodiments of the current invention endo-parasites and ecto-parasites can be controlled with ivermectin, doramectin, moxidectin, selamectin, either alone, in combination with each other or with other therapeutic and non-therapeutic compounds.

As another example, conditions of flea or tick infestations (including larvae kill or prevention) may be treated through one or more of the following medicaments, wherein the medicament is a component of the present compositions: imidacloprid, nitenpyram, lufenuron, fipronil, and milbemycin oxime. These medicaments can be maintained stable in a present liquid composition to prevent and kill fleas and their larvae.

Antiparasitic drugs can be used to prevent parasitic infections including tapeworm, pinworm, hookworm, roundworm and whipworm. The drugs milbemycin oxime and lufenuron can be admixed in the present invention to prevent hookworm, roundworm or whipworm in the current invention. In addition, praziquantel can be used for the prevention of tapeworm, fenbendazole for the prevention of roundworm and tapeworm and pyrantel pamoate can be used to prevent a pinworm infection.

Further medicaments that can be admixed with the liquid compositions of the current invention include antihistamines. Illustrative antihistamines that can be combined into the present composition include chlorpheniramine, hydroxyzine, clemastine, diphenhydramine.

Additionally, medicaments that act as non-steroidal anti-inflammatory drugs (NSAIDS) can be administered to a pet in the liquid supplement compositions of the current invention. Medicaments useful as NSAIDS include: carprofen, etodolac, piroxicam, ketoprofen, deracoxib, meloxicam, asprin, meclofenamic acid, and the like.

Compounds that exhibit anti-bacterial and antibiotic activity are also examples of useful medicaments herein. Examples of medicaments that exhibit antibacterial and antibiotic activity include ampicillin, amoxicillin, amoxicillin clavulanate, cefadroxil, cephalexin, clindamycin, doxycycline, enrofloxacin, erythromycin, metronidazole, ormetoprim/sulfa, sulfadiazine, sulfadimethoxine, tetracycline, trimethoprim/sulfa, and marbofloxacin. Common bacterial infections that can be treated with the antibiotics and antibacterials admixed in the current invention include periodontal disease, bite wound infections, mixed upper respiratory infections, abcesses, pyoderman, bacterial cystitis, bacterial otitis externa, colitis, prostatis, anal sac disease, sever ulcerative keratitis, pyometra, infections associated with chemotherapy, and lyme disease. These conditions can be treated with a number of medicaments utilized in accordance with the present invention, each condition varying in the duration of treatment required as shown in the illustrative chart below; which is not intended to be limiting of the invention in any manner.

| | | | Systemic |
|---|---|---|---|
| Bacterial | Duration of | | Antibiotic/Antibacterial |
| Infections | Treatment | | Agent Used |
| Periodontal | 7-28 | days | penicillin, clindamycin, |
| disease/stomatitis | | | ampicillin, amoxicillin, |
| | | | metronidazole, cephalexin, |
| | | | tetracycline, doxycycline |
| Bite wound | 10-14 | days | amoxicillin, clavamox, |
| infections | | | cefadroxil, cephalexin |
| Mixed upper | 7-14 | days | tetracycline, amoxicillin, |
| respiratory | | | clavamox, doxycycline |
| infection | | | |
| Abscesses, | 10-14 | days | amoxicillin, clavamox, |
| unknown origin | | | metronidazole, |
| | | | enrofloxacin, celphalexin, |
| | | | cefadroxil. |
| Pyodermas | 12-16 | weeks | cephalexin, clavamox, |
| | | | enrofloxacin, marbofloxacin, |
| | | | clindamycin, eryhromycin, |
| | | | ormetoprim-sulfa, |
| | | | trimethoprim-sulfa |
| | | | oxacillin |
| Bacterial cystitis | 2-12 | weeks | ampicillin, amoxicillin, |
| | | | clavamox, cephalexin, |
| | | | enrofloxacin, |
| | | | trmethoprim-sulfa |
| Infections | 10-14 | days | ampicillin, amoxicillin, |
| secondary to | | | gentamicin, amikacin, |
| virals infection, | | | |
| parvovirus, FIV, | | | |
| FeLV, panleukoopenia | | | |
| Bacterial Otitis | 2-6 | weeks | clavamox, cephalexin, |
| Externa | | | enrofloxacin |
| Colitis | 10-30 | days | metronidazole, tylosin, |
| | | | neomycin |
| Prostatitis | 2-8 | weeks | ampicillin, amoxiciilin, |
| | | | clavamox, cephalexin, |
| | | | enrofloxacin, erythromycin, |
| | | | chloamphenical, |
| | | | trimethoprim-sulfa |
| Anal Sac disease | 10-14 | days | cefadroxil, cephalexin, |
| | | | clavamox, enrofloxacin |
| Sever ulcerative | 10-14 | days | amoxicillin, clavamox, |
| keratitis | | | cephalexin, cefadroxil |
| Pyometra | 2-3 | weeks | amoxicillin, clavamox, |
| | | | cephal |
| Infections | 10-14 | days | clavamox, cephalexin, |
| associated with | | | gentamicin, amikacin, |
| chemotherapy | | | enrofloxacin |
| Lyme disease | 3-6 | weeks | coxycyclline, amoxicillin, |
| | | | tetracycline, minocycline. |
| Malabsorption/ | 2-8 | weeks | amoxicillin, ampicillin, |
| maldigestion, | | | metronidazole, gentamicin |
| IBD, and small | | | |
| intestinal bacterial | | | |
| overgrowth | | | |
| Pneumonia | 3-6 | weeks | cephalexin, |
| | | | trimethoprim-sulfa, |
| | | | clavamox |
| Infections | 3-6 | weeks | amoxicillin, clavamox, |
| secondary to | | | tetracycline, cephalexin |
| chronic bronchitis | | | |
| Feline | 6-8 | weeks | clavamox, cephalexin, |
| cholangiohepatitis | | | metronidazole |
| Pyelonephritis | 4-12 | weeks | ampicillin, amoxicillin, |
| | | | clavamox, trimethoprim-sulfa, |
| | | | chloamphenical, |
| | | | enrofloxacin |
| Leptospirosis | 4-6 | weeks | penicillin, ampicillin, |
| | | | amoxicillin, enrofloxacin, |
| | | | streptomycin, tertacycline |
| Mastitis | 3-4 | weeks | ampicillin, amoxicillin, |
| | | | cephalexin, |
| | | | trimethoprim-sulfa |
| Septic arthritis | 3-6 | weeks | amoxicillin, clavamox, |
| | | | cephdroxil, cephalexin, |
| | | | enrofloxacin |
| Osteomyelitis | 3-6 | weeks | amoxicillin, cephalexin, |
| | | | cephazolin, clindamycin, |
| | | | enrofloxacin, amikacin, |
| | | | gentamicin, metronidazole |
| Otitis | 3-6 | weeks | amoxicillin, clavamox, |
| media/interna | | | cefadroxil, cephalexin, |
| | | | enrofloxacin |

Other examples of these anti-bacterial agents include bis-guanidino antibacterials such as chlorhexidine, hexetidine, alexidine, myxovirescin, cetyl pyridinium chloride, minocycline, doxycycline, chlortetracycline and other tetracycline antibacterials; anionic antibacterials such as triclosan, nisin and other antibiotics, malabarcone C and other argingipain inhibitors; ofloxacin and other quinolone antibacterials; sulfadiazine; actinobolin; histatins; bactenicin and other peptide anti-bacterials.

In addition, common prophylactic antibiotic usage for diseases include the following antibiotics/antibacterials that can be admixed into the liquid composition of the current invention, including; for example:

| | | | Systemic |
|---|---|---|---|
| Common prophylactic | | | Antibiotic/Antibacterials |
| antibiotic usage | Duration | | Used |
| Contaminated lacerations, | 5-10 | days | amoxicillin, clavamox, |
| traumatic wounds | | | cefadroxil |
| Prior to dentistries | 3-7 | days | amoxicillin, penicillin, |
| | | | clindamycin |
| Perioperative to | 24 | hours | cefazolin |
| orthopedic surgery | | | |
| Perioperative to | 24 | hours | cefazolin |
| intraocular surgery | | | |
| Perioperative to | 2-7 | days | cefazolin, ampicillin, |
| gastrointestinal | | | gentamicin, amikacin, |
| surgery | | | metronidazole |
| Gastoenteritis | 5-10 | days | ampicillin, amoxicillin, |
| of unknown origin | | | clavamox, metroniddazole, |
| or of presumed | | | erythomycin, axithormycin |
| bacterial origin | | | |
| Open bone fractures | 10-14 | days | cefazolin, cephalexin, |
| | | | ampicillion, amoxicillin, |
| | | | clavamox |

A treatment plan, duration and appropriate medicament for protozoal infections is also exemplified below:

| | | | Systemic |
|---|---|---|---|
| Protozoal | | | Antibiotics/Antibacterial |
| infection | Duration | | Agents Used |
| Toxoplasmosis | 3-6 | weeks | clindamycin, |
| | | | trimethoprim-sulfa |
| Giardiasis | 5-7 | days | metronidazole |
| Trichomoniasis | 5-7 | days | metronidazole |

Additionally a treatment plan, duration and appropriate medicament for Rickettsial Infections are shown below:

| | | | Systemic |
|---|---|---|---|
| Rickettsial | | | Antibiotic/Antibacterial |
| Infections | Duration | | Agents Used |
| Ehrlichiosis | 10-21 | days | doxycycline, tetracycline, |
| | | | monocycline, |
| | | | chloramphenicol |
| Rocky Mountain | 7-10 | day | doxycycline, tetracycline, |
| Spotted Fever | | | minocycline |
| Hemobartonellsosis | 14-21 | days | doxycycline, tertracrycline, |
| | | | enroflozcin |

There are many common chronic conditions of companion animals that can be treated with medicaments added to the liquid compositions of the current invention. These conditions include but are not limited to heart disease, neurologic disease, endocrine disease, gastrointestinal disease, obstipation, colitis, urinary disease, cystitis, hemolymphatic disorders/oncology, musculoskeletal disease, dermatologic disease, chronic pyodermas, ophthalmic diseases, ear disease, behavioral disorders, nutritional disorders, appetite stimulant, pain medications, sedatives, antidotes and antidiarrheals. Specific medicaments that can be used to prevent these common diseases are exemplified in the chart below:

| | Medicament |
|---|---|
| Heart Disease | |
| Congestive Heart | enalapril, rurosemide, sprinolactone, |
| Failure | hydrochlorthiazide, digoxin, atenolol, |
| Cardiomyopathy | taurine, diliazem, aspirin, carnitine |
| Arrhythmis | procainamide, propranolol, quinidine |
| Hypertension | Amlodipine |
| Respiratory Diseases | |
| Collapsing Trachea | butophanol, hydrocodone |
| Bronchitis | prednisone, theophylline, aminophylline, |
| | albuterol, terbutaline, dexamethasone |
| Neurologic Diseases | |
| Seizures | phenobarbital, diazepam, KBr, felbamate |
| Endocrine Disease | |
| Diabetes Mellitus | insulin, glipzide |
| Hypothyroidism | 1-thyroxine |
| Hyperthyroidism | methimazole |
| Hyperadrenocorticism | lysodren |
| Hypoadrenocorticism | fludrocortisone, prednisone |
| Gastrointestinal | |
| Diseases | |
| Malabsorption/ | antibiotics, vitamins, H2 blockers |
| Maldigestion disorders | |
| Inflammatory Bowel | loperamide, prednisone, antibiotics, |
| Disease | azathiprine, chlorambucil, |
| GI ulcerations | H2 Blockers, metoclopramide, sucralfate, |
| | ondansetron |
| Obstipation | cisapride, DSS lactulose, erythromycin |
| Colitis | metronidazole, tylosin, sulfasalzine, |
| | prednisone |
| Chronic Hepatitis | ursodeoycholate, SAMe, antibiotics, |
| | prednisone |
| Hepatitic Lipidosis | taurine, zitamins, Zinc, carnitine, |
| | s-adenosyl methionine, SAMe |
| Exocirne Pancreatic | pancreatic enzymes, H2 blockers, |
| Insufficiency | antibiotics, vitamins |
| Urinary Disease | |
| Chronic Renal | calcitriol, phosphate binders, H2 blockers, |
| Failure | potaasium gluconate |
| Cystitis | antibiotics, urinary acidifiers |
| Urolithiasis | antibiotic, allopurinol,, potassium citrate, |
| | sodium bicarbonate, 2-MPG, D-penicillamine |
| Urinary Incontinence | phenylpropanolamine, DES, ephedrine |
| Chronic Prostatitis | antibiotics |
| Hemolymphatic | |
| Disorders/Oncology | |
| Immune Hemolytic | prednisone, cyclophophamide, azathioprine, |
| Anemia | danazol, cyclosporine, |
| Lymphosarcoma | prednisone, cyclophophamide, chlorambuscil, |
| | lomustine, prioxicam, melphalan |
| Musculoskeletal | |
| Diseases | |
| Degenerative/ | aspririn, carprofen, etodolac, cosequin, |
| Osteoarthritis | deracoxib, meloxicam, ketoprofen, |
| | meclofenamic acid |
| Dermatologic Disease | |
| Atopy, allergies | diphenhydamine, chlorphenarimine, |
| | hydroxyzine, clemastine, amitriptylline, |
| | prednisone, fatty acids, trimeprazine |
| Chronic {yodermas | antibiotics |
| Immune-mediated | prednisone, dexamethsone, triamcinolone, |
| skin disease | azathioprine, cyclophosphamide, |
| | chlorambucil, vitamin E |
| Opthalmic Diseases | |
| Glaucoma | methazolamide |
| Various Infections | antibiotics |
| Ear Disease | |
| Chronic Otitis | antibiotics |
| Externa | |
| Behavioral | amitriptylline, clomipramine, alprazolam, |
| Disorders | fluoxetine, deprenyl, buspirone, diazepam, |
| | sertraline, paroxetine |
| Nutiritional | |
| Disorders | |
| Appetitie stimulant | cyproheptadine, oxazepam |
| Pain Medications | NSAIDS, butorphanol |
| Sedatives | acepromazine, diazepam, phenobarbital |
| Antidotes | acetylcysteine, apomorphine, thiamine, |
| | succimer, vitamin K1 |

Antibodies are also an example of medicaments in accordance with the composition of the current invention. The antibodies can be specifically formulated antibodies or other specific transfer factor-like component that are immunized against a selected antigen such as a pathogenic bacteria. Polyclonal antibodies can be used for the destruction and removal of foreign macromolecules or antigens that will bind to a number of epitopes on a single antigen. Polyclonal antibodies can be collected by purifying the antibodies from blood collected from animals that have been injected with a selected foreign antigen. Examples of animals that may be used for polyclonal antibody purification include a chicken, rabbit, sheep or donkey. In addition monoclonal antibodies that will bind to a single epitope of an antigen can also be purified and used as medicaments against foreign antigens in accordance with the composition of the current invention. A mouse is an example of an animal that may be used for monoclonal antibody purification.

Other medicaments that have plaque anti-adherent properties, wherein the agents are derived from morpholino-amino alcohols, such as delmopino, octapinol, and other surface-active agents such as those derived from cationic and anionic surfactant classes may be utilized in the current invention. In general, antibacterial agents and antifungal agents used to treat infections may also be used.

In addition, other active ingredients that may be used for a variety of disorders in an animal include prednisone and prednisolone as catabolic steroids, phenobarbital for controlling seizures, furosemide as a diuretic, phenylpropanolamine for urinary incontinence.

Treatment of a companion animal may vary in dosage and type of medicament used depending on the size, age, breed or other specific characteristics of the companion animal. As an example, diarrhea is treatable with the liquid compositions of the current invention in companion animals, however the medicaments that are beneficial to the animals for diarrhea may vary depending on the age of the animal as exemplified in the chart below:

| | Types of Medicament for treatment |
|---|---|
| Diarrhea in Dogs | |
| Young dogs | prophylactic antibiotics, parasiticidal |
| | drugs |
| Middle-aged | metronidazole, tylosine, sulfasalazine, |
| to Older dogs | misoprostol, prednisone, antibiotics, |
| | hypoallergenic diets, gastrointestinal |
| | protectants, parasiticidal drugs, |
| | anti-emetics. |
| Diarrhea in Cats | |
| Young cats | parasiticidal drugs, sulfadimethoxine, |
| | trimethoprim-sulfa, metronidazole, |
| | Prophylactic Antibiotics |
| Middle-aged | prednisone, antibiotics, hypoiallergenic |
| to older cats | diets, sulfadimthoxine, trimethoprim-sulfa, |
| | metronidazole, clindamycin, gastrointestinal |
| | protectants |

A single medicinal agent or a combination of medicinal agents are also included and can be combined in a liquid composition of the current invention.

Flavorants

Any of a variety of animal meats, broths, or fats may be utilized as components of the present compositions. For example, animal meats such as chicken, pork, beef, veal, fish, and the like may be utilized. Advantageously, such meats are in particle or chunk form, such that the composition maintains an overall liquid form, such as spray-dried animal meats. Broths and fats of any animal meats may be used. In addition, artificial or other natural flavorant may be used to increase palatability of the compositions of the current invention.

The liquid compositions of the current invention may comprise a range from about 0.00001% to about 99% flavorant, from about 0.0001% to about 75% flavorant, from about 0.001 to about 50% flavorant, from about 0.01 to about 30% flavorant, from about 0.1% to about 20% flavorant, from about 1% to about 10% flavorant, from about 2% to about 6% flavorant, from about 3% to about 5% flavorant, all by weight of the composition.

Water

The liquid compositions further comprise at least about 50% water, by weight of the composition. The compositions are typically intended for use by companion animals as a supplement to ordinary dietetic needs. As such, these compositions are advantageously provided as drinking waters, gravies, or other supplements. Drinking waters may be fully or partially substituted for ordinary drinking water provided to the companion animal, or may even be in contact with, or admixed with, companion animal food. Gravies, as described herein, are broadly defined. Gravies may be any gravy, topping, sauce, or other liquid mixture. Gravies may have a viscosity which is greater than distilled water at ambient temperature. Gravies may be orally administered directly to the companion animal, but are advantageously contacted or admixed with food prior to oral administration.

In alternative embodiments, the compositions may comprise at least about 50% water, at least about 60% water, at least about 70% water, at least about 80% water, from about 50% to about 99% water, from about 60% to about 97% water, from about 70% to about 95% water, or from about 75% to about 90% water, all by weight of the composition. The water included at these levels includes all added water and any water present in combination components, for example, broths.

The present compositions may have any pH, provided that the composition is adapted for use, particularly ingestion, by a companion animal. In optional embodiments of the present invention, the present compositions have a pH of less than about 7, less than about 6, less than about 5, less than about 4, less than about 3.5, from about 2 to about 7, from about 2.5 to about 5, from about 2.5 to about 4, or from about 2.5 to about 3.5. Those compositions having a pH of less than about 3.5 are particularly preferred, as these compositions may not require refrigeration upon exposure to air such to provide shelf-stability over time and may not require aseptic packaging processes.

If necessary, the present compositions may comprise one or more acidulants in order to reach, and maintain, the desired pH. Acidity can be adjusted to and maintained within the requisite range by known and conventional methods, e.g., the use of one or more acidulants.

### Optional Components of the Present Compositions

The compositions herein may comprise additional optional components to enhance, for example, their performance in treating a particular condition, a desirable nutritional profile, and/or organoleptic properties. Such optional components may be dispersed, solubilized, or otherwise mixed into the present compositions. Non-limiting examples of optional components suitable for use herein are given below.

Nutrients

The supplements herein may optionally, but preferably, be fortified further with one or more nutrients, especially one or more vitamins and/or minerals. Non-limiting examples of such vitamins and minerals, include niacin, thiamin, riboflavin, folic acid, pantothenic acid, biotin, vitamin A (including vitamin A (retinol), β-carotene, retinol palmitate, or retinol acetate), vitamin C, vitamin B₂, vitamin B₃, vitamin B₆, vitamin B₁₂, vitamin D, vitamin E, vitamin K, iron, zinc, copper, phosphorous, potassium, iodine, chromium, molybdenum, fluoride, calcium, manganese, magnesium, or boron. Other therapeutic agents that can be maintained stable in supplements of the current invention and that are generally known in the art to provide a health benefit to a pet include but are not limited to the following: fructooligosaccharide (FOS) for the improvement of digestive health; lutein, probiotics for the improvement of digestive health; glucosamine for joint and bone health and chromium for the promotion of weight loss.

Antioxidants

Examples of antioxidants that may be optionally admixed in the current invention include alpha-tocopherol, alkyl gallate derivatives, nordihydroguaiaretic acid, ascorbic acid, citric acid, sodium metabisuphate, and sodium sulphite. Butylated hydroxy anisole and butylated hydroxy toluene may also be use in the current invention as an antioxidant.

Omega-3-Fatty Acids

One or more omega-3-fatty acids may be added to the present supplements. The omega-3-fatty acid optionally utilized herein may be any omega-3-fatty acid or combination of omega-3-fatty acids. Non-limiting examples of omega-3-fatty acids that are suitable for use herein include eicosapentaenoic acid (also known as EPA), docosahexaenoic acid (also known as DHA), and mixtures thereof. Omega-3-fatty acids are often derived from marine (fish) sources, including menhaden (a herring-like fish), or other sources such as flax.

Preservatives

One or more preservatives may additionally be utilized herein. Preferred preservatives include, for example, sorbate, benzoate, and polyphosphate preservatives. Preservatives may optionally be avoided wherein the pH is manipulated to levels which are less than about 3.5.

Emulsifiers and Oils

One or more emulsifiers and/or oils may also be included in the present supplement compositions for texture and opacity purposes. Typical emulsifiers and oils useful herein include, for example, mono-diglycerides, lecithin, pulp, cottonseed oil, and vegetable oil.

Suspending Agents

One or more suspending agents may be used in the present supplement compositions to produce viscous mixtures or compositions. Commonly used suspending agents include tara gum, gellan gum, guar gum, xanthan gum, gum arabic, gum ghatti, tragacanth gum, locust bean gum, carboxymethylcellulose, alginate, and the like. Particularly preferred gums include xanthan gum, tara gum and guar gum.

### Methods of the Present Invention

The methods of the present invention comprise orally administering (i.e., through ingestion) a composition of the present invention to a companion animal for treating conditions in companion animals. In one embodiment herein, administration of medicaments in a composition may result in treatment of any one or more of the following conditions; ectoparasites and endoparasites generally, including flea, tick, mosquito, larvae, heartworm, hookworm, roundworm, whipworm and other parasites.

The compositions of the present invention are most preferably ingested by companion animals. The compositions may be ingested as a supplement to normal dietetic requirements.

As used herein, the term “orally administering” with respect to the companion animal means that the animal ingests or a human is directed to feed, or does feed, the animal one or more compositions herein. Wherein the human is directed to feed the composition, such direction may be that which instructs and/or informs the human that use of the composition may and/or will provide the referenced benefit, for example, treatment of flea and tick in companion animals. For example, such direction may be oral direction (e.g., through oral instruction from, for example, a veterinarian or other health professional), radio or television media (i.e., advertisement), or written direction (e.g., through written direction from, for example, a veterinarian or other health professional (e.g., scripts), sales professional or organization (e.g., through, for example, marketing brochures, pamphlets, or other instructive paraphernalia), written media (e.g., internet, electronic mail, or other computer-related media)), and/or packaging associated with the composition (e.g., a label present on a container holding the composition). As used herein, “written” means through words, pictures, symbols, and/or other visible descriptors. Such information need not utilize the actual words used herein, for example, “medicaments”, “companion”, or “adapted for use”, but rather use of words, pictures, symbols, and the like conveying the same or similar meaning are-contemplated within the scope of this inventions.

The compositions described herein may be used as a supplement to ordinary dietetic requirements, or may be nutritionally balanced for those companion animals that have difficulty ingesting solid foods. Administration may be on an as-needed or as-desired basis, for example, once-monthly, once-weekly, or daily (including multiple times daily, or with each feeding). When utilized as a supplement to ordinary dietetic requirements, the composition may be administered directly to the companion animal or otherwise contacted with or admixed with companion animal food. In the preferred embodiment, the composition is maintained in a squeezable bottle for ease of administration with dosage instruction attached. Other methods of administration include providing single serving container such that the owner of a companion animal can discard the packaging after pouring the contents onto a companion animal food. Kits for multiple servings of the liquid compositions are also provided. In addition, a compartmentalized kit to separate a liquid composition from a medicament, where a medicament may not be maintained stable in a liquid composition, are provided such that a medicament can be added separately to a liquid composition and to a companion animal food immediately before feeding. The amount of composition utilized may be dependent on a variety of factors, including the identity of medicament, condition being treated, the health of the animal, preference of the animal as determined by the guardian of the animal or other person administering the composition, the quality of the companion animal food, and size or breed or the companion animal.

### Methods of Making

The presently described compositions are made according to methods that will be well known by the ordinarily skilled artisan. The current invention provides a method of administering a medicament to a companion animal. To illustrate, the compositions of the present invention may be prepared by dissolving dispersing, or otherwise mixing all components singularly or in suitable combinations together, and in water where appropriate, agitating with a mechanical stirrer until all of the ingredients have been solubilized or adequately dispersed. An illustrative process to manufacture the composition involves the following steps:
1. Add water to a tank.
2. Add antioxidant to chicken fat and mix well.
3. Under constant agitation, add liquid FOS and chicken fat to the water. Mix thoroughly.
4. Pre-mix solids meat powder, broth powder, xantham gum, vitamins and mineral pre-mixes, and yeast to form a “meat pre-mix”.
5. Under constant agitation, slowly add meat pre-mix and mix well to ensure powder is well dispersed. (Alternatively, the xantham gum could be added using well known high shear techniques to ensure adequate dispersion of the gum. Other solids can also be added individually with constant mixing.)
6. Pass product batch through a disintegrator or other high shear dispersing equipment to ensure all powders (particularly the gum) is well dispersed and no large clumps of powder remain.
7. Pre-mix vegetables ingredients into a “vegetable pre-mix”, including beet pulp, flax and vegetables.
8. Slowly add vegetable pre-mix to batch under constant agitation. Mix well.
9. Heat batch to 195° F. and hold for 5 minutes.
10. Cool batch to at least 130° F.
11. Add ½ of predicted level of phosphoric acid and mix well.
12. Add potassium sorbate, mix well.
13. Add flavors and mix.
14. Add additional phosphoric acid to achieve the target pH. Mix well.

In an embodiment of the current invention, in order to obtain a composition that is stable at ambient temperature with a medicament admixed therewithin, including medicaments that cannot survive dry food extrusion, the gravy is heated in a sterilization process from about 195° F. to about 200° F. for five minutes, and then cooled. The product is in a liquid form so the active ingredients can be added before or after heating, depending on the specific needs of the medicament being added. In the preferred embodiment of the current invention a liquid composition is maintained at a pH of about 3, thereby allowing the gravy topper to be heat treated at less extreme conditions and temperatures than those currently used in an extrusion processes. Lower heat conditions allows for admixture of a broad range of medicaments into a gravy topper or other liquid supplement composition of the present invention that could not otherwise be added in an extrusion process. Sterilization temperatures in the range of about 170° F. to about 240° F. can be used in further embodiments of the current invention to produce a liquid composition supplement for companion animals. In other embodiments of the current invention, sterilizing techniques that may be used include irradiation sterilization and high pressure sterilization. In addition, flavorants added to the compositions of the current invention further allows for ease of administration of medicaments to a pet.

Examples of compositions of preferred embodiments of the liquids supplement compositions of the current invention are as follows. Specifically, the formulation for a gravy topper in beef, chicken and bacon flavors are shown below.

### EXAMPLE 1

A beef-flavor gravy topper is prepared by combining the following components with ivermectin for the prevention and treatment of heartworm.

| Component | Wt % |
|---|---|
| Ivermectin | 0.00025 |
| Fructooligosaccharide | 5.3 |
| Chicken Fat | 3.0 |
| Spray-Dried Beef Particles | 2.0 |
| Spray-Dried Beef Broth | 1.0 |
| Beet Pulp | 0.4 |
| Xanthan Gum | 0.53 |
| Potassium Sorbate | 0.32 |
| Brewers Yeast | 0.16 |
| Flax Seed | 0.16 |
| Vegetables | 0.2 |
| Vitamins | 0.06 |
| Minerals | 0.04 |
| Antioxidant | 0.01 |
| Phosphoric Acid | 0.95 |
| Beef Flavor | 0.1 |
| Caramel color | 0.05 |
| Water | Remainder |

### EXAMPLE 2

A chicken-flavor gravy topper is prepared by combining the following components with the medicament lufenuron for the prevention and treatment of oral flea and tick.

| Component | Wt % |
|---|---|
| Lufenuron | 0.4 |
| Chicken Fat | 3.0 |
| Spray-Dried Chicken Particles | 2.0 |
| Spray-Dried Chicken Broth | 1.0 |
| Beet Pulp | 0.4 |
| Xanthan Gum | 0.53 |
| Potassium Sorbate | 0.32 |
| Brewers Yeast | 0.16 |
| Flax Seed | 0.15 |
| Vegetables | 0.2 |
| Vitamins | 0.06 |
| Minerals | 0.04 |
| Antioxidant | 0.01 |
| Phosphoric Acid | 0.95 |
| Chicken Flavor | 0.53 |
| Water | Remainder |

### EXAMPLE 3

A bacon flavored gravy topper is prepared by combining the following components with the medicament (S)-methoprene for the prevention of fleas.

| Component | Wt % |
|---|---|
| (S)-methoprene | 0.9 |
| Chicken Fat | 3.0 |
| Spray-Dried Pork | 2.0 |
| Spray-Dried Pork Broth | 1.0 |
| Beet Pulp | 0.4 |
| Xanthan Gum | 0.53 |
| Potassium Sorbate | 0.32 |
| Brewers Yeast | 0.16 |
| Flax Seed | 0.15 |
| Vegetables | 0.2 |
| Vitamins | 0.06 |
| Minerals | 0.04 |
| Antioxidant | 0.01 |
| Phosphoric Acid | 0.95 |
| Bacon Flavor | .25 |
| Palatability Spike | 0.05 |
| Water | Remainder |

1. A liquid composition comprising:
a medicament;
a flavorant; and,
water;
wherein said composition is essentially free of sugars and is adapted for use by a companion animal.

2. The liquid composition in accordance with claim 1 comprising at least about 50% water, by weight of said composition.

3. The liquid composition in accordance with claim 1 comprising at least about 80% water, by weight of said composition.

4. The liquid composition in accordance with claim 1 comprising from about 0.00001% to about 99% of said medicament, by weight of said composition.

5. The liquid composition in accordance with claim 4 having a pH of from about 3 to about 7.

6. The liquid composition in accordance with claim 4 wherein the medicament is selected from the group consisting of: imidacloprid, nitenpyram, lufenuron, fipronil, milbemycin oxime, and combinations thereof.

7. The liquid composition in accordance with claim 4 wherein the medicament is selected from the group consisting of: moxidectin, ivermectin, pyrantel milbemycin oxime, lufenuron, selamectin, and combinations thereof.

8. The liquid composition in accordance with claim 4 wherein said medicament is an antibody.

9. A method of treating a condition in a companion animal comprising orally administering the composition in accordance with claim 1 to said animal.

10. The method in accordance with claim 9 wherein the condition is selected from the group consisting of flea conditions, tick conditions, heartworm conditions, bacterial conditions, viral conditions, and combinations thereof.

11. The method of treating a condition in accordance with claim 9 wherein said liquid composition is administered daily.

12. The method of treating a condition in accordance with claim 9 wherein said liquid composition is administered weekly.

13. The method of treating a condition in accordance with claim 9 wherein said liquid supplement composition is administered monthly.

14. The method of treating a condition in accordance with claim 9 wherein said liquid composition is administered with a pet food.

15. A kit comprising:
a container; and,
a composition housed in said container, wherein said composition comprises of a medicament, a flavorant, and water, wherein said composition is essentially free of sugars and is adapted for use by a companion animal.

16. A kit in accordance with claim 15 comprising a plurality of containers.

17. A kit comprising:
a compartmentalized container; and,
two or more compositions housed in said container, wherein said composition comprises of a medicament, a flavorant, and water, wherein said two or more compositions are essentially free of sugars and are adapted for use by a companion animal.

18. A kit in accordance with claim 17 comprising a plurality of compartmentalized containers.

19. A kit comprising:
a compartmentalized container;
a first composition comprising a medicament, wherein said first composition is housed in a first compartment of said container; and,
one or more compositions housed in a compartment of said container which is not said first compartment, wherein said compositions comprise of a flavorant, and water, wherein the compositions are essentially free of sugars and adapted for use by a companion animal.

20. A liquid composition, comprising:
a medicament;
a flavorant; and,
water;
wherein said composition is essentially fee of tomato flavor and is adapted for use by a companion animal.

21. The liquid composition in accordance with claim 20 comprising at least about 50% water, by weight of said composition.

22. The liquid composition in accordance with claim 20 comprising at least about 80% water, by weight of said composition.

23. The liquid composition in accordance with claim 20 comprising from about 0.00001% to about 99% of said medicament, by weight of said corposition.

24. The liquid composition in accordance with claim 23 having a pH of from about 3 to about 7.

25. The liquid composition in accordance with claim 23 wherein the medicament is selected from the group consisting of: imidacloprid, nitenpyram, lufenuron, fipronil, milbemycin oxime, and combinations thereof.

26. The liquid composition in accordance with claim 23 wherein the medicament is selected from the group consisting of: moxidectin, ivermectin, pyrantel, milbemycin oxime, lufenuron, selamectin, and combinations thereof.

27. The liquid composition in accordance with claim 23 wherein said medicament is an antibody.

28. A method of treating a condition in a companion animal comprising orally administering the composition in accordance with claim 20 to said animal.

29. The method in accordance with claim 28 wherein the condition is selected from the group consisting of flea conditions, tick conditions, heartworm conditions, bacterial conditions, viral conditions, and combinations thereof.

30. The method of treating a condition in accordance with claim 28 wherein said liquid composition is administered daily.

31. The method of treating a condition in accordance with claim 28 wherein said liquid composition is administered weekly.

32. The method of treating a condition in accordance with claim 28 wherein said liquid supplement composition is administered monthly.

33. The method of treating a condition in accordance with claim 28 wherein said liquid composition is administered with a pet food.

34. A kit comprising:
a container; and,
a composition housed in said container, wherein said composition comprises of a medicament, a flavorant, and water, wherein said composition is essentially free of tomato flavor and is adapted for use by a companion animal.

35. A kit in accordance with claim 34 comprising a plurality of containers

36. A kit comprising:
a compartmentalized container; and,
two or more compositions housed in said container, wherein said compositions comprise of a medicament, a flavorant, and water, wherein said two or more compositions are essentially free of tomato flavor and are adapted for use by a companion animal.

37. A kit in accordance with claim 36 comprising a plurality of compartmentalized containers.

38. A kit comprising:
a compartmentalized container;
a first compartment comprising a medicament, wherein said first composition is housed in a first compartment of said container; and,
one or more compositions housed in a compartment of said container which is not said first compartment, wherein said compositions comprise of a flavorant and water, wherein the compositions are essentially free of tomato flavor and are adapated for use by a companion animal.

39. A process for manufacturing a liquid composition comprising;
admixing a medicament, a flavorant, and water; and,
sterilizing said liquid composition at a temperature of from about 170° F. to about 240° F., wherein said liquid composition is adapted for use by a companion animal.
